(19) United States
(12) Patent Application Publication
(10) Pub. No.: US 2022/0205798 A1
(43) Pub. Date: Jun. 30, 2022

(54) COMPUTER-IMPLEMENTED METHOD AND SYSTEM FOR CONTENT RECOMMENDATION TO A USER ON BOARD A VEHICLE

(71) Applicant: ITALDESIGN-GIUGIARO S.P.A., Torino (IT)

(72) Inventors: Emanuele RIVELLA, Torino (IT); Andrea AMATUCCI, Grottammare (Ascoli Piceno) (IT)

(21) Appl. No.: 17/609,893

(22) PCT Filed: May 8, 2020
(86) PCT No.: PCT/IB2020/054375

§ 371 Date: Nov. 9, 2021

(30) Foreign Application Priority Data
May 9, 2019 (IT) 102019000006659

(51) Int. Cl. G01C 21/34; G01C 21/36; G06V 40/10; G06F 16/9538; H04N 21/25; G06K 9/62

(52) U.S. Cl. CPC G01C 21/3484; G01C 21/3679; G06K 9/6262; G06F 16/9538; H04N 21/251; G06V 40/103

(57) ABSTRACT

A computer-implemented method for recommendation of contents to a user on board a vehicle includes learning a content preference criterion starting from a history of previous content selections by the user and automatically selecting a content from a database of available contents based on the learned preference criterion. Automatic selection is based on at least one of vehicle occupancy status, vehicle status and vehicle travel condition. A system for recommending contents to a user on board a vehicle includes an automatic learning engine based on a predetermined automatic learning model for learning a content preference criterion, data collection modules for acquiring data indicative of vehicle occupancy status, vehicle status and vehicle travel condition, and an inference engine for automatic selection of a content from the database of available contents on the basis of at least one of the acquired vehicle occupancy status, vehicle status and vehicle travel condition.

The present invention relates to recommendation systems or engines and more specifically to a computer-implemented method and a system for recommending contents to a user of a vehicle, in particular a computer-implemented method for recommending contents according to the preamble of claim 1 and a system for recommending contents to a user of a vehicle according to the preamble of claim 10.

A recommendation system or recommendation engine is a content filtering software that creates custom recommendations specific to a user, so as to help him/her in his/her choices. A recommendation system is a machine learning model which processes the preferences of a user, the data relating to him/her and contextual data to provide content suggestions as part of an activity carried out by the user or in response to a specific request coming from the user.

Today more than ever, artificial intelligence is growing rapidly in every technological sector and supports numerous applications. In the automotive industry an intelligent on-board system capable of learning the behaviors and preferences of a user, such as the driver of the vehicle or a passenger thereof, more generally an occupant of the vehicle, allows the user's actions to be predicted and/or personalized recommendations to be provided, thereby simplifying the control of the vehicle in a broad sense, i.e. controlling the vehicle travel or controlling on-board devices. This is achieved through recommendation systems, applied to numerous sectors.

U.S. patent application US 2013/0030645 to Panasonic Corporation discloses an information and entertainment (infotainment) system of a vehicle for the delivery of multimedia contents to the occupants of a vehicle based on features of the occupants, wherein the content recommendation model requires that the vehicle occupants provide feedback on the recommendations provided.

The present invention aims to provide a recommendation system and method applicable to the automotive context.

According to the present invention, this object is achieved by a computer-implemented method for recommending contents to at least one user on board a vehicle having the features referred to in claim 1.

Particular embodiments are the subject of the dependent claims, whose content is to be understood as an integral part of the present description.

A further subject of the invention is a system for recommending contents to at least one user on board a vehicle having the features referred to in claim 10.

Advantageously, the recommendation system and method according to the present invention are designed to learn from the behavior and habits of an occupant of a vehicle or from multiple occupants of the vehicle, as well as from actual events affecting the vehicle and from the contexts surrounding the vehicle, so as to provide suggestions for actions to be taken on board the vehicle and useful content for the vehicle occupants.

The recommendation system and method according to the present invention may be conveniently applied to an on-board infotainment system, for example in contexts for managing multimedia contents, for navigation, for human-machine interface.

Advantageously, the recommendation system and method according to the present invention allow multimedia or navigation recommendations to be provided which may be individually shared among a plurality of vehicle occupants.

Unlike the prior art of US 2013/0030645, the invention does not provide for vehicle occupants to provide feedback on the recommendations provided. The content recommendation system, through reinforcement learning, is able to independently and sequentially evaluate the actions to be proposed in relation to the current and previous state of the system itself. Advantageously, in one embodiment, the quality of an action is closely linked to the effectiveness of the outputs provided in relation to a reward value, not assigned by the user but automatically evaluated by the system based on the frequency of selections by the user on the actions proposed by the system.

Advantageously, for the three contexts of multimedia content, navigation, and human-machine interface management, the recommendations are generated without the need for user interaction. Each proposed suggestion, whether accepted by the user or not, is recorded and used to improve subsequent recommendations.

Further features and advantages of the invention will appear more clearly from the following detailed description of an embodiment thereof, given by way of non-limiting example with reference to the accompanying drawings, in which:

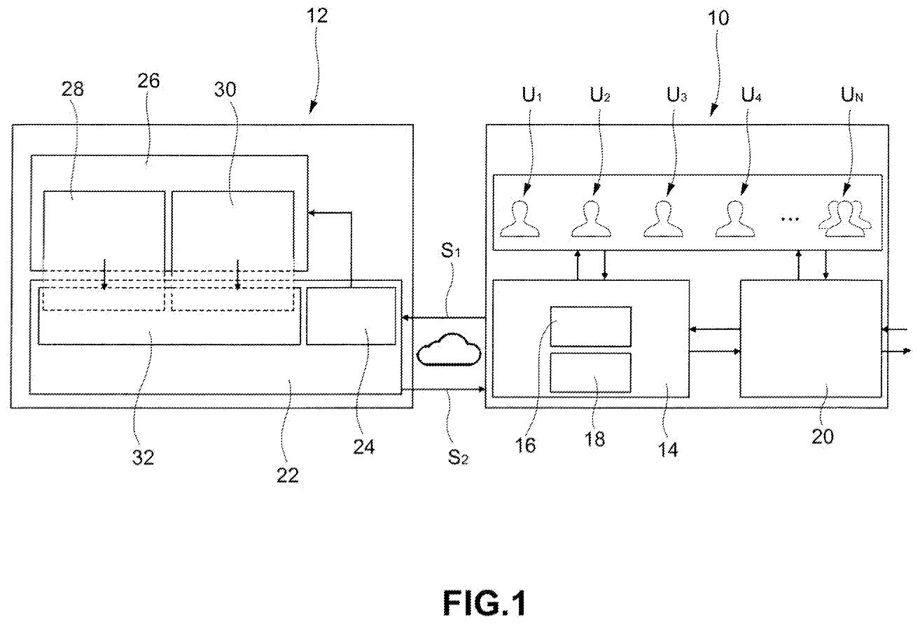

FIG. 1 is a block diagram of a first embodiment of a recommendation system according to the invention, in which the decision algorithms of the system reside in the cloud;

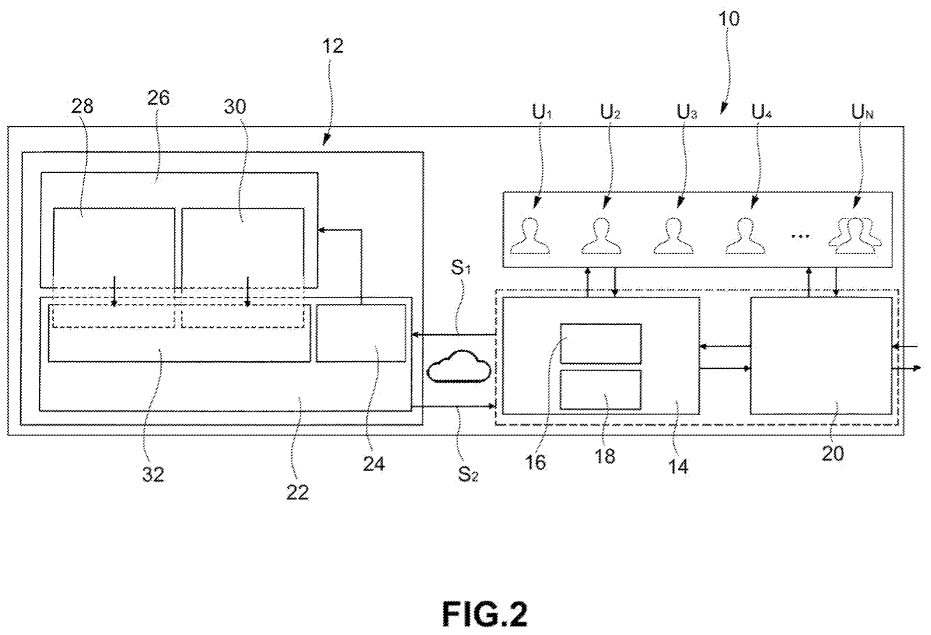

FIG. 2 is a block diagram of a second embodiment of a recommendation system according to the invention, in which the decision algorithms of the system reside on board the vehicle;

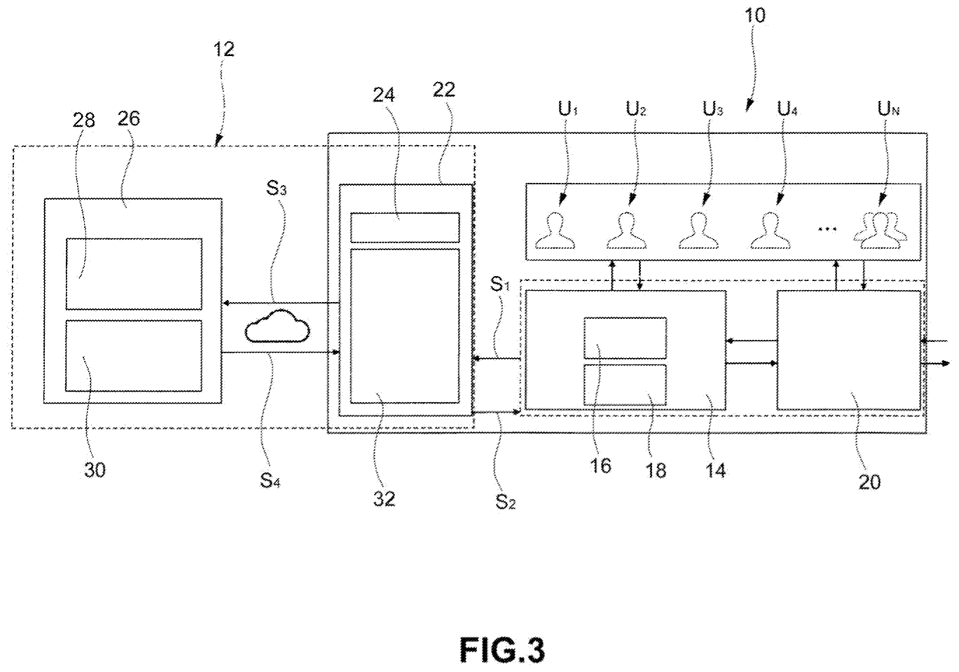

FIG. 3 is a block diagram of a third embodiment of a recommendation system according to the invention of the hybrid type;

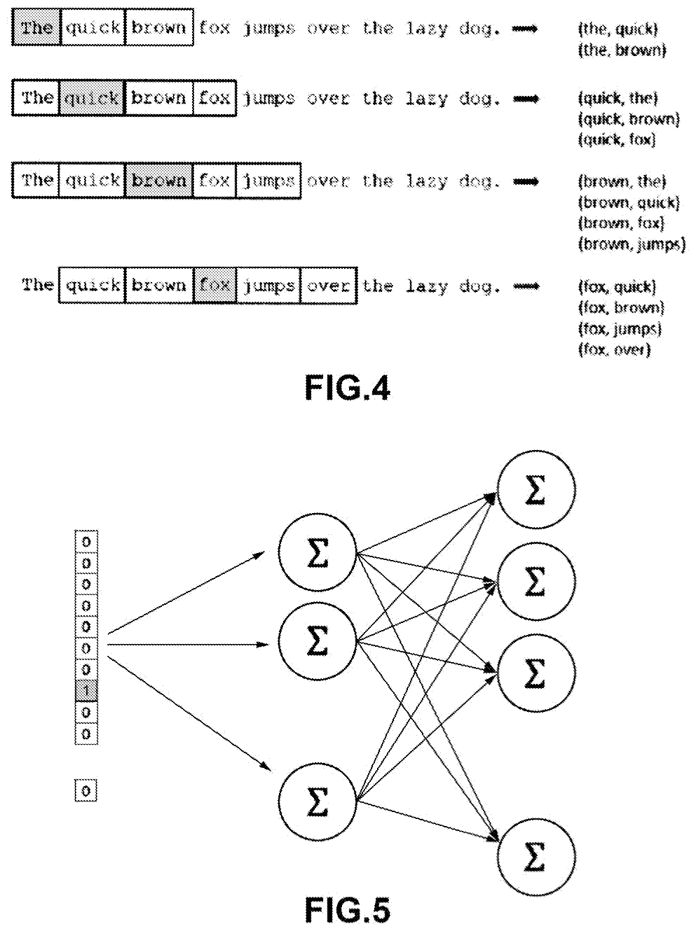

FIG. 4 shows a training technique for processing a natural language; and

FIG. 5 shows an exemplary neural network architecture for implementing an automatic learning in the context of the recommendations of music tracks.

With reference to the embodiment of FIG. 1, a recommendation system associated with a vehicle 10 is generally indicated with reference numeral 12.

The vehicle 10, for example a motor vehicle, may accommodate N occupants, users of the recommendation system, indicated with U₁, U₂, U₃, U₄, . . . , U_{N} in the figure. They may interact with a human-machine interface 14, such as—by way of example—a control console or a distributed interface in association with the seats of the vehicle, by means of known input devices 16, such as—by way of example—tactile or voice recognition devices, and known output devices 18, such as—by way of example—one or more screens or an on-board audio system. A set of on-board sensors of the vehicle is generally indicated with reference numeral 20 and comprises sensors adapted to detect the presence of the occupants U₁-U_{N} and their features, for example biometric features for recognizing the occupants, their location on the vehicle and their state, sensors adapted to detect the interaction of at least one occupant of the vehicle with the human-machine interface 14, for example for selecting contents of an on-board application, and sensors adapted to detect conditions of the vehicle and of the use of the vehicle as well as environmental contexts outside the vehicle.

A complex power supply signal S₁ containing data representative of the vehicle occupants, data representative of respective actions or selections of contents at the human-machine interface and data representative of vehicle conditions and environmental contexts external to the vehicle is transmitted by the vehicle 10 to a communication module 22 of the recommendation system 12, and more precisely to a data collection module 24 of the communication module.

The data thus collected is provided to a machine learning engine 26 based on predetermined machine learning models, for example including a deep learning engine 28 and a reinforcement learning engine 30, the outputs whereof are shared with an inference engine 32 adapted to provide one or more recommendations to the human-machine interface 14 of the vehicle 10 through a recommendation signal S₂.

FIG. 2 shows an alternative embodiment of the recommendation system of FIG. 1, in which elements or components identical or functionally equivalent to those illustrated in FIG. 1 have been indicated with the same reference numerals.

Basically, the system architecture is similar to that described above with reference to FIG. 1, from which it differs only in that the recommendation system 12 is integrated on board the vehicle 10, so that the signals S₁ and S₂ are transmitted on on-board communication lines.

FIG. 3 shows a further alternative embodiment of the recommendation system of FIG. 1 or 2, in which elements or components identical or functionally equivalent to those illustrated in FIGS. 1 and 2 have been indicated with the same reference numerals.

Basically, the system architecture is similar to that described above with reference to FIG. 1, from which it differs only in that the communication module 22 of the recommendation system 12, including the data collection module 24 and the inference engine 32, is integrated on board the vehicle 10, while the machine learning engine 26 including the deep learning engine 28 and the reinforcement learning engine 30 are located in the cloud whereby the data collection module 24 is arranged to transmit training data to the machine learning engine 26 through a signal S₃ and the inference engine 32 is arranged to receive updated data from the deep learning engine 28 and from the reinforcement learning engine 30 through a signal S₄.

The on-board sensors 20 are designed to detect a series of input information variables on which the system bases its learning, which include data relating to vehicle occupants, data relating to the selection of content by vehicle occupants, as well as conditions of the vehicle or of the use of the vehicle.

More specifically, the on-board sensors 20 are designed to acquire, by way of non-exhaustive example, at least one of the following data:
a history of content selections by vehicle occupants, their use and features of the elements of such content;
a recognition of the vehicle occupants, obtainable for example by means of a biometric recognition system, such as a facial recognition system, or through a manual selection, for example performed in a vehicle access step, by means of a specific learning model;
a classification of the age of the vehicle occupants, obtainable through a biometric recognition system—for example a facial recognition system—or through initial settings, useful for a more accurate operation of the recommendation system and for triggering initial recommendations, which may be different in the case of subjects of different age groups (adults, children);
weather conditions;
a time stamp, adapted to identify, for example, the time of the day or the day of the week;
the duration of a trip;
the destination of a trip;
social events on the calendar;
vehicle driving conditions;
vehicle conditions (status);
any passengers accompanying the driver;
events or social relationships in the proximity of the place where the vehicle is located.

The information or data acquired by the on-board sensors and their use for the purposes of the recommendation system and method according to the invention are described in detail below.

### Content Selection History

The system is designed to learn from data and actions previously performed by the vehicle occupants, as well as the features of the elements, i.e. the specific data relating to each type of element (for example, for a music playback application, the features of the elements are: song title, artist, album, genre, year, etc.). This is intended to proactively generate content for applications required by vehicle occupants that are consistent with the behavior and habits of each of them.

### Recognition of Vehicle Occupants

The recognition of the vehicle occupants, and in particular the biometric recognition of the driver, for example facial recognition, allows not only the vehicle occupants to be recognized in a set of registered occupants, but also the acquisition of mood information as objective as possible of the vehicle occupants as a result of which the system may recommend different types of multimedia content, points of interest during navigation or routines (or functions, or applications) in a human-machine interface.

### Age Classification of Vehicle Occupants

Depending on the age of the vehicle occupants, the system may recommend different types of multimedia content, points of interest in navigation or routine of the human-machine interface. In the first case, this feature is useful for a more accurate prediction and for the automatic suggestion of initial preferences of multimedia contents suited to the age of the vehicle occupants. In the second case, this feature is used for a more accurate recommendation of points of interest consistent with the age of the occupants of the vehicle who may drive there, for example of play areas in the event that children are recognized on board the vehicle, entertainment areas such as cinemas and the like if more occupants classified in the same age group are recognized, preferably in predetermined time scenarios.

### Weather

Depending on the weather conditions, the system may recommend different types of multimedia content, for example related to the mood of the vehicle occupants, as well as different points of interest compatible with the current weather conditions.

### Time Stamp

Based on a time stamp, the system is able to learn the habits of use of the vehicle in different time intervals, since, for example, a vehicle user may have different habits depending on the time of the day and day of the week. For example, in the case of multimedia content, during the weekend a user of the vehicle may listen to different types of music, and the type of music may also vary between the morning, on the trip from home to the workplace, and the evening, on the return trip from work to home. In the case of navigation, during the weekend a user of the vehicle may be attracted by different types of points of interest, and the point of interest may change according to the time of the day and the type of trip. Similarly, in the case of the on-board human-machine interface, the system may recommend a specific routine according to the time of the day, a routine including a sequence of actions, for example the execution of a multimedia content playback application, selecting a particular multimedia content therein, then running a navigation application and automatically setting the destination and related trip details.

### Duration of a Trip

Based on the predetermined or estimated duration of a trip, the system is able to recommend multimedia content whose duration of playback is compatible with the duration of the trip, especially for multimedia video content, for example content whose overall duration of use is not longer than the predetermined or estimated duration of the trip. In the case of navigation, depending on the duration of a trip, the system may automatically suggest points of interest for a travel break, for example restaurants. In the case of content displayed by an on-board human-machine interface, the system may learn, for example, that in the case of long trips a specific driver of the vehicle may have preferences for the running of a foreground navigation function.

### Destination of a Trip

Based on the predetermined destination of a trip, the system is designed to recommend specific multimedia contents, specific points of interest such as restaurants or accommodation, specific routines of the human-machine interface, each dependent on the aforementioned destination.

### Calendar Events

Based on preset calendar events, the system is able to control personalized human-machine interface routines, for example to proactively run a navigation application, activate recommendations for points of interest and automatically set a trip destination.

### Vehicle Running Conditions

Depending on the vehicle's current running conditions, the system is designed to recommend specific multimedia content, for example according to the sport or comfort driving modes, as well as to provide more accurate points of interest recommendations or to suggest the activation of specific routines of the human-machine utility interface, for example for displaying driving parameters.

### Vehicle Condition

Depending on the condition or status of the vehicle, assessed in real time, the system may recommend points of interest, such as refueling stations, or in the case of diagnosing vehicle anomalies or scheduled maintenance, the system may recommend the vehicle parking at specific workshops or emergency parking areas. In this way, the system may report anomalies to the driver through the human-machine interface.

### Passengers Accompanying the Driver

Depending on the recognition of passengers accompanying the driver, for example in a group of previously registered passengers, the system may provide recommendations shared by all passengers.

Social Events or Relationships in the Vicinity of the Place where the Vehicle is Located

The system is designed to suggest specific events, such as concerts, or meeting places where events and shows take place, for example learned from databases or newsletters accessible through an on-board communication system, as well as automatically set a trip destination and calendar events related to social events in the proximity of the place where the vehicle is located.

The features of the machine learning engine and the inference engine in preferred cases of application of the recommendation system according to the invention to the automotive context will be described below, respectively in the case of multimedia recommendations, such as recommendations for playing music and videos in the vehicle interior, in the case of navigation recommendations, such as point of interest recommendations, and in the case of human-machine interface recommendations.

In a computer-implemented method for suggesting multimedia contents, the system according to the invention is designed to provide recommendations for music or video contents.

Multimedia content recommendations are based on a selection history by at least one vehicle user and generate a list of suggested music track playbacks. The list of playbacks is automatically updated after a predetermined number of selections in order to guarantee a balance between content exploitation and exploration.

Advantageously, the machine learning model is designed to recommend the preferred music contents by a user, but also to propose new music contents which may be appreciated by the same user.

If only the driver is present in the vehicle, the music recommendation system is based on a recommendation model built on the aforementioned user. However, the system is also designed to operate with a plurality of vehicle occupants, in which case the recommendation model offers shared recommendations, i.e. personalized recommendations for all vehicle occupants simultaneously.

The mathematical model at the basis of the recommendation system of the invention is based on a natural language neural processing network and on a supervised learning approach, applied to build an “item-based” collaborative filtering model, that is based on descriptor elements of the music tracks and users.

The neural network is modeled and applied in an innovative way: the music tracks and the users of the vehicle are described using (embedded) vectorial representations thereof. Similar music tracks have distributed representations or embeddings very close to each other in the vector space, a condition which is technically describable as cosine similarity.

In order to recommend a music track similar to all the tracks already played for a user, all the music tracks are summarized in a single vector representation: this result represents an embedding of the user and in the vector space is the centroid of all the embeddings of the descriptor elements of the music tracks. After creating a user embedding, the system creates a recommendation of a list of tracks to be played with the main tracks sorted according to the cosine similarity between their embeddings and the embeddings of the users present simultaneously on board the vehicle.

The shared recommendations that the system allows offering are not a fusion of favorite music tracks extracted from the history of each user, but a single list of tracks to be reproduced suited to the preferences of all users simultaneously on board the vehicle in a particular listening session. This result is obtained by calculating a result of similarity of the musical tracks as an average between two cosine similarities, calculated between the embeddings of the descriptor elements of the music tracks and the embeddings of the users. Therefore, the similarity result is averaged with a popularity result, similarly to what is normally done in the case of a single recommendation (for a single user).

The recommendation system according to the invention is also able to avoid “cold start” problems through an intelligent initialization of the system itself.

The recommendation system is advantageously developed to be trained in a first step in order to find the parameters of the model and in a second step to learn in real time from the actions of one or more users. All user actions are provided as input to the model to train and adjust user embeddings in real time.

The neural network has been modeled to accept multiple input variables, so it is fully updatable and customizable according to the initial requirements and contexts of the vehicle.

More specifically, unlike the basic models of the known recommendation systems that operate with information of attributes referring to the users and to the descriptor elements of the music tracks, such as audio features or metadata, also indicated as content-based recommendation systems, the recommendation system according to the present invention is based on an innovative application of the collaborative filtering model. The difference between the two is that the prior art requires only a set of features, related to the users or to the descriptor elements of the music tracks, while the invention requires a large set of data, usually indicated by the name of user and descriptor elements matrix. This matrix is a table in which the rows are represented by the users and the columns are represented by the descriptor elements of the music tracks, as shown below.

Item

| User | Item 1 | Item 2 | . . . | Item n |
|---|---|---|---|---|
| User 1 | R11 | R12 | . . . | R1n |
| User 2 | R21 | R22 | . . . | R2n |
| . . . | . . . | . . . | . . . | . . . |
| User m | Rm1 | Rm2 | . . . | Rmn |

The generic cell in position (i,j) of the table contains a score given by the i-th user with respect to the j-th descriptor element.

In general, the score of a descriptor element of music tracks is represented by the evaluation attributed by a user, but this is not always the case. For example, in a music recommendation system, the user does not have to evaluate the music tracks, so a score may not always be available. In this case, an alternative score may be given by the number of plays of a music track, adjusted according to its popularity.

Although the requirements for collaborative filtering are much more difficult to meet due to the large amount of data that summarize the interactions between users and descriptor elements of music tracks, its performances are far superior. Since the matrix of users and descriptor elements of the music tracks is a sparse matrix, that is, most of the values of its cells are not known, collaborative filtering was used to insert the missing scores. This is possible due to the fact that observed evaluations are often highly correlated between different users and descriptor elements of music tracks. This correlation may be used to infer the missing cell value. In this way, for a user who has not evaluated a descriptor element, it is possible to predict the relative score and recommend it if the predicted evaluation is high.

The collaborative filtering method applied to the recommendation system according to the invention is based on a memory method, in which the evaluations of the combinations between users and descriptor elements of the music tracks are predicted through their neighbours. In detail, it has been used by using “item based” collaborative filtering, i.e. based on the descriptor elements of the music tracks, in which the idea is to set descriptor elements of the music tracks similar to the target descriptor element. The predicted evaluation of the target descriptor element is calculated as the weighted average of similar descriptor elements. For example, in the recommendation of music tracks it is important to suggest music tracks that are similar to those already played.

The implementation of a recommendation system for collaborative filtering is described in more specific terms below.

Each descriptor element of a music track is transformed into a vector of descriptor elements. In this way the recommendation system may calculate a quantitative similarity between two music tracks using a correlation index between their vectors. The vectors of descriptor elements of the music tracks are calculated through the personalized integration of an advanced machine learning technique, the “item embedding” technique. Originally born in the processing of natural language, this technique is able to calculate accurate vectors of descriptor elements of music tracks (“items”) with scattered data and a high dimensionality. Similar music tracks will have item embeddings very close in the vector space.

The innovation introduced in researching item embeddings is implemented through the creation of a sliding window of music tracks which moves along a sequence, as it is implemented in natural language processing techniques (FastText), for example shown in FIG. 4.

FIG. 4 shows a training technique in the processing of a natural language, taken from “Word2Vec Tutorial—The Skip-Gram Model” by Chris McCormick, Apr. 19, 2016. Whenever a window scrolls, it contains a different sub-sequence of music tracks. A neural network has been created which receives the central music track from the window, or target, and predicts the other music tracks of the window, or context.

In the representation on the left of FIG. 4, the application of a sliding window technique to a sequence of words is described, whereas in the recommendation model of the present invention the words are replaced by music tracks.

In order to feed the neural network, the data is converted into a particular format: each sub-sequence of length n, created by the sliding window, provides n−1 records. Each record includes a pair of descriptor elements, the first element is the target, while the second element is one of the contexts. The image on the right in FIG. 4 shows the records. Each record feeds the neural network, which receives the first element as an input in order to predict the second element as an output.

The architecture of the neural network used is shown in FIG. 5, also taken from “Word2Vec Tutorial—The Skip-Gram Model” by Chris McCormick, Apr. 19, 2016.

The input layer is a “one-hot encoding” representation of the input descriptor element (first element of the record). Therefore, the length of the layer corresponds to the number of distinct music tracks belonging to the data set. Each cell represents one of these descriptor elements and has a value equal to 1 if the corresponding element is the same as the input, otherwise a value equal to 0. Therefore, the “one-hot” coding is a vector of all 0 except a single cell valued at 1.

The neural network has a hidden layer of smaller size compared to the size of the input layer, generally of 300 neurons.

The output layer has the same size as the input layer, whose cells are the output probabilities of the individual descriptor elements. The loss function keeps the output layer as close as possible to the “one-hot” coding representation of the output descriptor element (second element of the record).

To obtain optimal values of the weights, a training step was carried out. All the information goes through the hidden layer. This layer is in fact a complex representation of the input layer and contains all the information of the input descriptor element. Therefore it is a correct vector representation of the input element, and therefore the best candidate to represent an item embedding.

The input values are also broken down into features. Assuming, for example, that the word <apple> is received as input, where < and > are special outline symbols, the word apple is divided into <ap, app, ppl, ple, le>, which are technically called trigrams. Once the architecture of the neural network has been constructed, the trigrams are also inserted in the input layer in order to obtain a representation of the hidden vector for each of them. The final embedding of the word “apple” and therefore the sum of the vectorial representations of its trigrams.

In the case of the invention, it is possible to break down a descriptor element of the music tracks into multiple features, such as the title of the music tracks, the name of the artists, the main genre and any other features of the music track and external context that one wants to include in a collection of predetermined initial requirements.

In this way it is possible to include multiple features in the neural network in order to calculate an embedding of each item of the music track. Using this innovative approach, it is possible to consider more information on the music track and the surrounding contexts, obtaining more accurate item embeddings.

For example, taking into consideration the features of the artist's name and the main genre of a music track, both may be represented through vectors. The final item embedding for the music track is the sum of the three vectorial representations of the title, artist and genre.

The advantage of this approach is that it allows calculating an item embedding of a music track even if some features are not available. For example, if there is a new music track, whose artist and genre are known, it is possible to calculate the relative item embedding by adding the vector representations of the artist and genre.

A high accuracy of the vector representation of rare music tracks is obtained by using sampling evaluation algorithms. The increase in training speed without loss in accuracy may be obtained by using a so-called negative sampling.

In general, in an item-based collaborative filtering the recommendation system proposes descriptor elements of the music tracks which are very similar to the descriptor elements which have been previously evaluated in positive terms. In the system of the invention, the recommendation system provides suggestions of music tracks which are similar to those already played. Furthermore, the system is able to offer unique recommendations in the case of a single user who is recognized as present in the vehicle, or shared recommendations in the case of a plurality of occupants who are on board the vehicle.

More in detail, to offer recommendations to a single user, the system of the invention uses its personal history of music tracks already played. Two music tracks are similar if their item embeddings have a high cosine similarity which represents the correlation index between two vectors. Its range is between 1 and −1. If the index is close to 1, the two vectors are very similar, while if the index is close to −1 the two vectors are very far apart in the vector space.

The formula is as follows:

$$similarity = cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}}$$

where Aᵢ and Bᵢ are the components of the vectors A and B.

In order to trace a recommended music track that is similar to all the music tracks already played, the following approach was used: all the music tracks are summarized in the history in a single vector representation; this is obtained by calculating a weighted average of all the item embeddings of the music tracks included in the history. The result is an embedding of the user and in the vector space it represents the centroid of all the embeddings of the descriptor elements of the music tracks (item embeddings).

The descriptor elements of the music tracks do not have the same weights in the average. In fact, newer music tracks have a heavier weight while previous tracks have lower weights. This is achieved through an exponential, parameterizable weight decay. With 0<α<1 the weight associated with a music track at time t−1 (the last music track played) is α, the weight of the music track at time t−2 is α², and so on. The weight decreases exponentially in the past.

After obtaining a user embedding, the recommendation system creates the recommendations of a list of songs to be played with the most interesting music tracks, sorted according to the cosine similarity between their item embeddings and the user embedding. Using the similarity of the music tracks and the popularity of the music tracks it is also possible to obtain a good balance between the requirements of exploitation and exploration and a satisfactory variety of artists in the list of songs to be played.

In more detail, to offer a shared recommendation, the recommendation system of the invention adopts the method described above also for multiple occupants of a vehicle who are on board the vehicle in the same time interval. At first, the system independently calculates embeddings for all occupants on board the vehicle. The main difference between the two models is that in this case, multiple user embeddings are generated.

Since the recommended music tracks must be close to all users, the similarity of the music tracks is calculated as the average of the similarities of n cosines, where n is the number of vehicle occupants, calculated between the item embeddings and the n embeddings of users. Then the similarity score is averaged with the popularity score in the same way as in the previous case.

The procedure adopted for the calculation of item embeddings is typical of the “supervised learning” technique. It is based on a large amount of initial data that allow training a supervised model and estimate its parameters, represented by the weights in the case of a neural network. Subsequently, the inference step is performed in which after the input data and the estimated parameters are acquired, the output results are obtained, represented by the item embeddings.

A common problem that collaborative filtering techniques generally have is the so-called “cold start” problem.

Since at the beginning of the use of the vehicle there is no history of previous selections or preferences for a user, the recommendation system would work randomly. Even during the first selections there is a short history and the recommendation system would overestimate the music tracks already played. In this case it takes some time to detect a user's real music preferences.

The solution adopted by the system of the present invention to avoid this problem is represented by an intelligent initialization of the system, which occurs during the registration of a user. When the user registers, the system proposes some artists and the user must select a predetermined number. These selections immediately enrich the user's history and are associated with a high weight. By virtue of this approach, the system is able to perform an intelligent initialization of the user embedding and offer appropriate recommendations right from the first selections.

The artists initially proposed are not suggested randomly, but are selected through, for example, a criterion of popularity and a technique of aggregation. In detail, a mixed Gaussian model is used to group the artists in a predetermined number of clusters and propose an artist for each of them. Using this technique it is possible to propose a predetermined number of popular artists at the beginning, which are different from each other. Once one of them is selected, the aggregation is again applied to the artists contained in the selected cluster. In this way, sub-aggregations are identified and a predetermined number of artists are proposed for each of them. This operation is advantageously repeated a predetermined number of times.

The initial selections of the artists represent a specialization of music preferences, obtainable during a user registration process. This ensures that the initial selections are not far from each other and that the centroid represents them all well.

The recommendations of video clips follow the logic described for the recommendation of music tracks, the only difference being related to the features of the video clips and the ways in which they are played according to the number of occupants of the vehicle, the location of the occupants on board the vehicle and the number of screens available to play video content.

As is also possible in the case of recommendations for music tracks, the recommendations of video clips may also be related to the location of an occupant on board the vehicle, for example in the case of a family scenario where two adult subjects are seated on the front seats and one or more children in the back seats.

In the case of recommendations of points of interest within a navigation system, the recommendation system of the invention offers suggestions relating—for example—to parking areas, restaurants and accommodation, using the information provided by the previous selections of a user. Again the recommendations are offered as a balance between exploitation and exploration requirements.

The recommendations of points of interest are made using a completely different approach from the previous one, in particular a calculation approach through a reinforcement learning technique. This technique has the property of being able to work without a training step and therefore without a set of starting data. This kind of algorithm begins to learn directly from a user's actions by discovering which actions bring the greatest reward. Reward is a type of feedback that the learning system obtains when it presents an action to select.

The points of interest are suggested using a classification obtainable by reinforcement learning and the system is updated by the rewards associated with the selections by a user.

Reinforcement learning uses training information that evaluates the actions taken rather than the instructions given. The evaluation of the feedbacks indicates how good an action was, but not whether it was the best or worst possible action.

The algorithm suggested herein represents a new application of the technique known as “k-armed bandit” in which a user is repeatedly offered a choice between k different options or actions. After each choice, the user receives a reward in the form of a numerical value chosen from a stationary probability distribution which depends on the actions that the user has selected.

The system chooses between k different actions, each of which corresponds to a specific state. To achieve this, the k-aimed bandit algorithm bases each action on an average reward.

The reward Q of an action a is calculated according to the following expression:

$$Q ( a ) = \frac{sum of rewards when a is selected}{number of times a is selected}$$

Generally a new reward may be equal to 1 if the feedback is positive, or equal to 0 if the feedback is negative.

The simplest rule that is generally adopted to select an action is to section the action with the highest average reward. The balance between exploration, i.e. actions that have never been carried out, and exploitation, i.e. actions that have been carried out and that have received positive reward, is performed using criteria based on higher confidence limits. The idea behind it is to add an uncertainty which operates as an adjustment of the balance between exploration and exploitation requirements, according to the formula

Q(α)+c×uncertainty

It follows the criterion that an action that has never been carried out has a high uncertainty, and the average reward increases, while an action that has been selected several times has a low uncertainty and the average reward decreases. In this way, when a new action is present, the system tries to propose it to receive a first feedback, or initial reward. The parameter c in the above formula works as an agreement parameter: with a high value of c it is possible to attribute exploration character to the algorithm, otherwise it is possible to achieve an exploitation character.

In the system of the invention, when a user requests recommendations of points of interest, the system may provide a list of recommended points of interest. The model suggests actions according to an assigned initial input including predetermined requirements, such as food categories, prices, rating and distance from current location for restaurant recommendations.

An average reward is associated with each input or category and is regulated by uncertainty (which is greater if the category has never been selected before and lesser if the category has already been selected several times). Then the categories are sorted by average reward and it is possible to obtain a classification of the recommended categories. When a new category is found, its average reward is initialized to the value 0 and with high uncertainty.

The number of recommendation lists is related to the number of vehicle occupants. Once the list of recommendations has been obtained, each user performs the action of selecting one of the points of interest as the destination point. The selected point of interest is associated with one or more characteristic states of the point of interest, for example a price state or a food category state. The average rewards related to these states are updated with a positive reward. On the contrary, all the points of interest arranged before the selected one, but which have not been selected, are penalized and updated with a negative reward.

In the case of a plurality of vehicle occupants, the action performed on one of the suggested lists may be applied as a common action to provide shared suggestions. This behavior may be applied for example in a family context or in all scenarios where different people use the same vehicle together.

As also in the case of the recommendation of multimedia contents, also in this context there is the problem of “cold start” without an appropriate initialization. In order to avoid this problem, the system proposes a selection of initial preferences which are considered as first positive reward.

Finally, as regards the recommendations in a human-machine interface, the system of the invention may suggest actions on the human-machine interface, for example it may suggest the action of playing a multimedia content or setting a specific navigation destination. These choices are learned from the actions that the user makes on a daily basis according to the contexts of use of the vehicle and the condition of the vehicle, the driving conditions of the vehicle and surrounding contexts.

In this way, the system may automatically suggest shortcuts for accessing applications provided by a human-machine interface, according to the habits of a user. It automatically predicts the contents of the applications to be displayed on a human-machine interface screen, for example the graphical user interface and the switching on of the vehicle interior lights may be customized according to the user's current mood or the vehicle running conditions or the external environmental conditions, or a combination thereof. Likewise, the position of the seats and the temperature of the passenger compartment may be customized.

Advantageously, the shared recommendations are independent of the interpersonal relationships between the vehicle occupants, but depend exclusively on the common history of actions carried out with one or more occupants. The recommendation system of the invention is always available and not initialized exclusively in case of external events. Each external event, action carried out by the occupant of the vehicle and the related context in which the action is carried out, are used for implementing or refining in runtime the vector model (embeddings) of one or more users in relation to the time stamp.

Equally advantageously, the profiling of a user is not strictly necessary for the creation of vectorial models and, consequently, for the suggestion of contents. The recommendation system is structured to provide content also to non-registered users with vectorial prediction models initialized and trained during a single session of use. In this case, profiling is performed in runtime based on the use of the vehicle for the user in the current session. With user profiling, the suggestions are more accurate and allow for multiple usage sessions.

The recommendation system of the invention is also characterized by the innovative ways in which the applied mathematical models have been integrated into the system. The modeling of user preferences and the consequent creation of a vector in the multidimensional space takes place with cross-analysis of previously trained data, actions and contexts, regardless of whether these actions and contexts have already been known by the system. The system is therefore able to cope with new actions and contexts (not necessarily present in the original data), thus self-learning the individual history of a user and adapting the training and suggestions based on the latter.

It should be noted that the proposed embodiment for the present invention in the foregoing discussion has a purely illustrative and non-limiting nature of the present invention. A man skilled in the art may easily implement the present invention in different embodiments which however do not depart from the principles outlined herein and are therefore included within the scope of protection of the invention defined by the appended claims.

For example, the techniques described in the contexts of multimedia content, navigation, human-machine interface management, or the algorithms for recommending multimedia content, points of interest during a navigation or routine (or functions, or applications) in a human-machine interface, each described in a specific example context, may in fact be used in all the management contexts described herein. Hence, vector representation (embedding) may be applied not only to the description of multimedia content and vehicle users, but also to the description of points of interest or functions of human-machine interface and vehicle users, as well as the newly applied algorithm of the technique known as “k-armed bandit” may be used not only for the creation of suggestions for points of interest or human-machine interfaces, but also for multimedia contents.

1. A computer-implemented method for content recommendation to at least one user on board a vehicle, comprising learning a content preference criterion starting from a history of previous content selections by said at least one user and automatically selecting at least one content from a database of available contents on the basis of said learned content preference criterion,
wherein automatic selection of at least one content is further performed based on at least one of a vehicle occupancy status, a vehicle status and a vehicle travel condition,
and wherein with a plurality of users occupying the vehicle, the content recommendation comprises the automatic selection of a content from the database of available contents as a function of an average of cosine similarities between embeddings of each content of said database of available contents and the embeddings of each user occupying the vehicle, an embedding of a content being a vector representation of predetermined descriptor elements of the content, and an embedding of a user occupying the vehicle comprising a vector representation of the descriptor elements of contents of the history of previous content selections by said user.

2. A computer-implemented method for content recommendation to at least one user on board a vehicle, comprising learning a content preference criterion starting from a history of previous content selections by said at least one user and automatically selecting at least one content from a database of available contents on the basis of said learned content preference criterion,
wherein automatic selection of at least one content is further performed based on at least one of a vehicle occupancy status, a vehicle status and a vehicle travel condition,
and wherein the content recommendation comprises the automatic selection of a content from the database of available contents through a reinforcement learning technique of the “k-armed bandit” type in which one or more users occupying the vehicle is offered a choice between k different contents.

3. The computer-implemented method of claim 1, wherein the vehicle occupancy status is detected on the basis of a recognition of one or more users occupying the vehicle among a group of registered users.

4. The computer-implemented method of claim 3, wherein said recognition of one or more users occupying the vehicle is obtained by a biometric recognition system or through a manual selection.

5. (canceled)

6. The computer-implemented method of claim 1, wherein the vehicle status comprises at least one of a vehicle running condition and an operating state of the vehicle.

7. The computer-implemented method of claim 1, wherein the vehicle travel condition comprises at least one of atmospheric conditions, a time stamp indicative of travel time, a predetermined duration of a trip, a travel destination, a social event scheduled in the time period of travel, an event or social relationships in proximity of a place where the vehicle is located.

8. The computer-implemented method of claim 1, wherein said at least one content comprises a multimedia content, a point of interest for navigation, a function or application of a human-machine interface.

9. A system for recommending contents to at least one user on board a vehicle, the system comprising:
a database of available contents and a memory device for storing a history of previous content selections by said at least one user; and
processing means comprising an automatic learning engine based on at least one predetermined automatic learning model, arranged for learning a content preference criterion from said history of previous content selections and for automatically selecting at least one content from said database of available contents on the basis of said learned content preference criterion,
wherein said processing means further comprise:
a signal or data collection module, configured to acquire at least a first signal or data indicative of a vehicle occupancy status, at least a second signal or data indicative of a vehicle status and at least a third signal or data indicative of a vehicle travel condition; and
an inference engine for automatic selection of said at least one content from said database of available contents also on the basis of at least one of the acquired vehicle occupancy status, vehicle status and vehicle travel condition,
and wherein said processing means are configured to implement the method for content recommendation of claim 1.

10. The system of claim 9, wherein said automatic learning engine comprises a deep learning engine and a reinforcement learning engine.

11. The system of claim 9, wherein said signal or data collection module, said automatic learning engine and said inference engine are integrated on board the vehicle.

12. The system of claim 9, wherein said signal or data collection module, said automatic learning engine and said inference engine are located in a cloud.

13. The system of claim 9, wherein said signal or data collection module and said inference engine are integrated on board the vehicle, and said automatic learning engine is located in a cloud.

14. The computer-implemented method of claim 2, wherein the vehicle occupancy status is detected on the basis of a recognition of one or more users occupying the vehicle among a group of registered users.

15. The computer-implemented method of claim 14, wherein said recognition of one or more users occupying the vehicle is obtained by a biometric recognition system or through a manual selection.

16. The computer-implemented method of claim 2, wherein the vehicle status comprises at least one of a vehicle running condition and an operating state of the vehicle.

17. The computer-implemented method of claim 2, wherein the vehicle travel condition comprises at least one of atmospheric conditions, a time stamp indicative of travel time, a predetermined duration of a trip, a travel destination, a social event scheduled in the time period of travel, an event or social relationships in proximity of a place where the vehicle is located.

18. The computer-implemented method of claim 2, wherein said at least one content comprises a multimedia content, a point of interest for navigation, a function or application of a human-machine interface.

19. A system for recommending contents to at least one user on board a vehicle, the system comprising:
a database of available contents and a memory device for storing a history of previous content selections by said at least one user; and
processing means comprising an automatic learning engine based on at least one predetermined automatic learning model, arranged for learning a content preference criterion from said history of previous content selections and for automatically selecting at least one content from said database of available contents on the basis of said learned content preference criterion,
wherein said processing means further comprise:
a signal or data collection module, configured to acquire at least a first signal or data indicative of a vehicle occupancy status, at least a second signal or data indicative of a vehicle status and at least a third signal or data indicative of a vehicle travel condition; and
an inference engine for automatic selection of said at least one content from said database of available contents also on the basis of at least one of the acquired vehicle occupancy status, vehicle status and vehicle travel condition,
and wherein said processing means are configured to implement the method for content recommendation of claim 2.

20. The system of claim 19, wherein said automatic learning engine comprises a deep learning engine and a reinforcement learning engine.

21. The system of claim 19, wherein said signal or data collection module, said automatic learning engine and said inference engine are integrated on board the vehicle.

22. The system of claim 19, wherein said signal or data collection module, said automatic learning engine and said inference engine are located in a cloud.

23. The system of claim 19, wherein said signal or data collection module and said inference engine are integrated on board the vehicle, and said automatic learning engine is located in a cloud.
